(19) United States
(12) Patent Application Publication
(10) Pub. No.: US 2025/0341646 A1
(43) Pub. Date: Nov. 6, 2025

(54) LEAST-SQUARES REVERSE TIME MIGRATION METHOD, SYSTEM, TERMINAL, AND STORAGE MEDIUM

(71) Applicant: SOUTHERN UNIVERSITY OF SCIENCE AND TECHNOLOGY, Shenzhen (CN)

(72) Inventors: Kai YANG, Shenzhen (CN); Jianfeng ZHANG, Shenzhen (CN)

(73) Assignee: SOUTHERN UNIVERSITY OF SCIENCE AND TECHNOLOGY, Shenzhen (CN)

(21) Appl. No.: 18/796,456

(22) Filed: Aug. 7, 2024

(30) Foreign Application Priority Data
May 6, 2024 (CN) 202410543467.4

(51) Int. Cl. G01V 1/28

(52) U.S. Cl. CPC G01V 1/282

(57) ABSTRACT

A least-squares reverse time migration method, system, terminal, and non-transitory computer-readable storage medium. The method includes: establishing a modeling operator based on the scattering potential, construct an approximate asymptotic inverse operator for the reflectivity function, build a relationship between the reflectivity function and the scattering potential, and obtain an approximate asymptotic inverse operator for the scattering potential based on the approximate asymptotic inverse operator for reflectivity and the relationship; acquiring seismic data collected by receivers as observed data, and performing imaging based on the approximate asymptotic inverse operator and the observed data to obtain an initial image; generating predicted data based on the initial image and the modeling operator, and calculating data residual between the observed data and the predicted data; iteratively updating the initial image based on the data residual and the approximate asymptotic inverse operator to obtain a target image. The imaging efficiency is improved.

### CROSS-REFERENCE TO RELATED APPLICATIONS

The present application claims priority to Chinese Patent Application No. 202410543467.4, filed on May 6, 2024. The content of aforesaid application is incorporated herein by reference.

### TECHNICAL FIELD

The present disclosure pertains to the field of geophysical exploration technology, particularly to a least-squares reverse time migration method, system, terminal, and computer-readable storage medium.

### BACKGROUND

As a key technology in the exploration of resources such as oil and gas, seismic migration plays a crucial role in imaging subsurface geological structures. However, due to complex overburdens, limited acquisition aperture, and limited bandwidth, traditional imaging techniques often suffer from issues such as uneven illumination, low spatial resolution, and poor continuity of reflection events. The advent of least-squares migration technology has effectively alleviated or overcome these problems, improving imaging quality.

In recent years, least-squares reverse time migration has become a key technology for imaging complex areas. Compared to traditional reverse time migration, least-squares reverse time migration offers numerous advantages, including compensating for uneven illumination, enhancing resolution, and recovering weak events. These improvements are achieved through iterative inversion by progressively decreasing the misfit between the observed data and the predicted data, in order to achieve an inverse effect of the modeling operator.

In the prior art, traditional least-squares reverse time migration technologies primarily use the adjoint operator of the modeling operator as the migration operator to implement the iterative inversion. However, the adjoint operator is not the inverse of the modeling operator. As a result, in order to achieve the inverse effect of the modeling operator, the traditional method typically requires numerous iterations, with each iteration involving substantial computational cost. This significantly limits the application efficiency of the method.

Therefore, the prior art still needs to be improved and developed.

### SUMMARY

The main purpose of the present disclosure is to provide a least-squares reverse time migration method, a system, a terminal and a storage medium, aiming to solve the problem in the prior art that the traditional least-squares reverse time migration technology requires a large number of iterations, leading to lower imaging efficiency.

In the first aspect, an embodiment of the present disclosure provides a least-squares reverse time migration method. The least-squares reverse time migration method includes steps of: establishing a modeling operator based on a scattering potential, constructing an approximate asymptotic inverse operator for a reflectivity function, building a relationship between the reflectivity function and the scattering potential, and deriving an approximate asymptotic inverse operator for the scattering potential based on the approximate asymptotic inverse operator for the reflectivity function and the relationship between the reflectivity function and the scattering potential; acquiring seismic data recorded by receivers as observed data, and performing imaging based on the approximate asymptotic inverse operator for the scattering potential and the observed data to obtain an initial image; generating predicted data by using the modeling operator based on the initial image, and calculating data residual between the observed data and the predicted data; iteratively updating the initial image based on the approximate asymptotic inverse operator for the scattering potential and the data residual to obtain a target image.

Optionally, in an embodiment of the present disclosure, the modeling operator based on a scattering potential is expressed as:

$$δ p ( {x}_{r} , ω ; {x}_{s} ) = {\int }_{Ω} i ω 𝒞 ( y ) f ( ω ) G ( y , ω ; {x}_{s} ) {𝒱}_{PP} ( y , θ ) G ( {x}_{r} , ω ; y ) d Ω . \qquad [ 10 ]$$

Among them, δp(xᵣ, ω; xₛ) is a reflected wavefield recorded by receivers, xᵣ is a coordinate of the receiver, ω is an angular frequency, xₛ is a coordinate of a source point, i is imaginary unit, y is a coordinate of a point in space, [symbol] is a coefficient related to an underground medium and a wave equation adopted, f is a source function, G is a Green's function, [symbol] is a real underground scattering potential, θ is a scattering angle, and Ω is integration domain.

The approximate asymptotic inverse operator for the reflectivity function is expressed as:

$${ℛ}_{PP}^{est} ( x , γ ; {x}_{s} ) = {\vert Q ( x ; {x}_{s} ) \vert}^{- 1} {\int }_{ω} {[ f ( ω ) G ( x , ω ; {x}_{s} ) ]}^{†} δ p ( x , ω ; {x}_{s} ) d ω . \qquad [ 13 ]$$

Among them,

$${ℛ}_{PP}^{est}$$

is an inverted reflectivity function image, γ is an incident angle, and Q is a source illumination compensation.

The relationship between the true reflectivity function and the true scattering potential is expressed as:

$${𝒱}_{PP} ( y , θ ) = 2 {ℛ}_{PP} ( y , γ ) {cos}^{2} γ .$$

Among them, [symbol] is a true reflectivity function of the underground medium, and the incidence angle γ is equal to a half of the scattering angle θ.

The approximate asymptotic inverse operator for the scattering function is then expressed as:

$${𝒱}_{PP}^{est} ( x , θ ; {x}_{s} ) = {\vert Q ( x ; {x}_{s} ) \vert}^{- 1} {\int }_{ω} {⌊ 2 f ( ω ) G ( x , ω ; {x}_{s} ) ⌋}^{†} {cos}^{2} γ δ p ( x , ω ; {x}_{s} ) d ω .$$

Among them,

$${𝒱}_{PP}^{est}$$

is an inverted scattering potential image and † represents complex conjugate.

Optionally, in an embodiment of the present disclosure, a back-propagated reflected wavefield in the approximate asymptotic inverse operator for the reflectivity function and the scattering potential is expressed as:

$$δ p ( x , ω ; {x}_{s} ) = - {\int }_{{S}_{0}} 2 \frac{\partial {G}^{†} ( {x}_{r} , ω ; x )}{\partial {n}_{0}} δ p ( {x}_{r} , ω ; {x}_{s} ) {dx}_{r} .$$

Among them, S₀ is an acquisition surface, n₀ is a normal direction of the acquisition surface.

Optionally, in one embodiment of the present disclosure, the initial image includes an initial scattering potential image; the iteratively updating the initial image based on the approximate asymptotic inverse operator for the scattering potential and the data residual to obtain a target image includes: simulating a source-side wavefield based on the source function and simulating a receiver-side wavefield based on the observed data or the data residual; inputting the source-side wavefield and the receiver-side wavefield into the approximate asymptotic inverse operator for the scattering potential to obtain an update of the scattering potential; updating the scattering potential based on the initial scattering potential image and the corresponding update; if the updated scattering potential image meets a preset requirement, designating the updated scattering potential image as the target image.

Optionally, in one embodiment of the present disclosure, the receiver-side wavefield is an amplitude-preserved receiver-side wavefield; simulating the source wavefield and the amplitude-preserved receiver-side wavefield includes: acquiring a velocity model and/or anisotropic parameter models, and solving the wave equation based on these models to obtain the source-side wavefield; recording boundary values of the source-side wavefield and the source-side wavefields of last two time steps; reversely reconstructing the source-side wavefield based on the recorded boundary values and the wavefields of the last two time steps; and at the same time, back-propagating the observed data or the data residual to obtain the amplitude-preserved receiver-side wavefield.

Optionally, in one embodiment of the present disclosure, the preset requirement is that a convergence criterion is met; if the updated scattering potential image meets a preset requirement, designating the updated scattering potential image as the target image includes: generating the predicted data based on the modeling operator and the updated scattering potential image and calculating an updated data residual between the observed data and the predicted data; if the updated data residual is within the convergence criterion, designating the updated scattering potential image as the target image.

Optionally, in one embodiment of the present disclosure, the preset requirement is that a preset iteration number is met; obtaining a current iterative number; if the current iterative number is greater than the preset iteration number, designating the scattering potential update image as the target image.

In the second aspect, an embodiment of the present disclosure further provides a least-squares reverse time migration system. The least-squares reverse time migration system includes: an asymptotic inverse operator construction module, configured to establish a modeling operator based on the scattering potential, construct an approximate asymptotic inverse operator for the reflectivity function, build a relationship between the reflectivity function and the scattering potential, and derive an approximate asymptotic inverse operator for the scattering potential based on the approximate asymptotic inversion operator for the reflectivity function and the relationship between the reflectivity function and the scattering potential; an imaging module, configured to acquire seismic data collected by receivers as observed data, and perform imaging by performing the approximate asymptotic inverse operator for the scattering potential on the observed data to obtain an initial image; a data residual calculation module, configured to generate predicted data based on the initial image and the modeling operator, and calculate the data residual between the observed data and the predicted data; an image iterative update module, configured to iteratively update the initial image by performing the approximate asymptotic inverse operator for the scattering potential on the data residual to obtain a target image.

In the third aspect, an embodiment of the present disclosure further provides a terminal. The terminal includes: a memory, a processor, and a least-squares reverse time migration imaging program stored in the memory and executable on the processor. The least-squares reverse time migration program implements the steps of the least-squares reverse time migration method as described above when executed by the processor.

In a fourth aspect, an embodiment of the present disclosure further provides a computer-readable storage medium, wherein the computer-readable storage medium stores a least-squares reverse time migration program, and when the least-squares reverse time migration program is executed by a processor, the steps of the least-squares reverse time migration method as described above are implemented.

Beneficial effects: The present disclosure provides a least-squares reverse time migration method, system, terminal and storage medium. The method involves a modeling operator based on the scattering potential, an approximate asymptotic inverse operator for the reflectivity function, a relationship between the reflectivity function and the scattering potential, and then obtaining an approximate asymptotic inverse operator for the scattering potential based on the approximate asymptotic inverse operator for the reflectivity function and the relationship between the reflectivity function and the scattering potential. The present method performs the iterative inversion with fewer iterations using the approximate asymptotic inverse operator. In this process, the true-amplitude back-propagated receive-side wavefield is obtained by injecting the observed data or the data residual as boundary conditions rather than sources at each receiver position. The method reduces the inversion iteration number, improves imaging quality, and ensures imaging efficiency.

### BRIEF DESCRIPTION OF THE DRAWINGS

In order to more clearly illustrate the embodiments of the present disclosure or the technical solutions in the prior art, the drawings required for use in the embodiments or the description of the prior art are briefly introduced below. Obviously, the drawings described below are only some embodiments recorded in the present disclosure. For those skilled in this field, other drawings can be obtained based on these drawings without creative work.

FIG. 1 is a flow chart of an embodiment of the least-squares reverse time migration method of the present disclosure;

FIG. 2 is a schematic diagram of a horizontal layered model adopted in a numerical simulation experiment provided in an embodiment of the present disclosure;

FIG. 3 is a comparison of the true values with extracted peak amplitudes of the traditional method and an embodiment of the present disclosure;

FIG. 4 is a schematic diagram of a complex model adopted in a numerical simulation experiment provided in an embodiment of the present disclosure;

FIG. 5 is a scattering potential image obtained by least-squares reverse time migration using an approximate asymptotic inverse operator in an embodiment of the present disclosure;

FIG. 6 is a reflectivity image obtained by least-squares reverse time migration using an approximate asymptotic inverse operator in an embodiment of the present disclosure;

FIG. 7 is a schematic structural diagram of an embodiment of the least-squares reverse time migration system of the present disclosure;

FIG. 8 is a schematic structural diagram of an embodiment of the terminal of the present disclosure.

### DRAWING LABELS

10. Least-squares reverse time migration system; 100. Asymptotic inverse operator construction module; 200. Data imaging module; 300. Residual calculation module; 400. Image iterative update module.

### DETAILED DESCRIPTION OF EMBODIMENTS

In order to make the objectives, technical solutions, and effects of the present invention clearer and more explicit, the following description will refer to the accompanying drawings of the embodiments of the present disclosure, providing a clear and comprehensive description of the technical solutions of the embodiments. The described embodiments are only possible technical implementations of the present disclosure and are not exhaustive. Based on the embodiments of the present disclosure, those skilled in the art can derive other embodiments without creative effort, and these embodiments also fall within the scope of the present disclosure.

In traditional least-squares reverse time migration technology, an adjoint operator is established based on the modeling operator. This technology uses the adjoint operator as the migration operator to image the scattering potential and then generates the predicted data using the modeling operator based on the obtained scattering potential image. These predicted data are then compared with the observed data, and any mismatches in the data-domain are back-projected into the image-domain by using the adjoint operator to obtain the model update. An updated scattering potential image is obtained based on the model update and the last scattering potential image. The process is iteratively repeated until a preset iteration number is reached. However, the adjoint operator is not the inverse of the modeling operator. Therefore, traditional methods often require numerous iterations to achieve the inverse effect of the modeling operator.

The adjoint operator used in the prior art is expressed as:

$${V}_{adj}^{est} ( x , θ ; {x}_{s} ) = {\vert Q ( x ; {x}_{s} ) \vert}^{- 1} {\int }_{ω} i ω 𝒞 ( x ) f ( ω ) {G ( x , ω ; {x}_{s} )}^{†} P ( x , ω ; {x}_{s} ) d ω \qquad 1 )$$

Among them,

$${V}_{adj}^{est}$$

represents the inverted scattering potential image by using the adjoint operator, x is an imaging point, θ is the scattering angle, xₛ is the coordinate of the source point, Q is the source illumination compensation, i is the imaginary unit, ω is the angular frequency, [symbol] is the coefficient related to the underground medium and the equation adopted, f is the source function, G is the Green's function, and P represents the back-propagated receiver-side wavefield used in prior art.

$$P ( x , ω ; {x}_{s} ) = - {\int }_{{S}_{0}} {G}^{†} ( {x}_{r} , ω ; x ) δ p ( {x}_{r} , ω ; {x}_{s} ) {dx}_{r} \qquad 2 )$$

Among them, † represents the complex conjugate, S₀ is the acquisition surface, δp(xᵣ, ω; xₛ) is the reflected wavefield recorded by receivers, and xᵣ is the coordinate of the receiver. The prior art performs imaging by applying the formula 1) and formula 2) to the observed data δp(xᵣ, ω; xₛ) to obtain the inverted scattering potential image

$${V}_{adj}^{est} ;$$

then generates the predicted data by the using the inverted scattering potential image

$${V}_{adj}^{est} ,$$

calculates the data residual between the observed data and the predicted data, and iteratively updates the image of the scattering potential by applying the adjoint operator to the data residual. However, in this process, the prior art treats the observed data or data residual as sources to generate the back-propagated receiver-side wavefield (that is, the observed data or data residual at receiver positions are injected as sources for back-propagation to obtain the receiver-side wavefield, but the obtained receiver-side wavefield does not correspond well to the amplitude of the true wavefield), which leads to a higher number of iterations, lower imaging efficiency, and poorer imaging accuracy.

The approximate asymptotic inverse operator of the present disclosure uses the recorded data or date residual at receiver positions as boundary conditions to obtain the back-propagated receiver-side wavefield.

Compared to the adjoint operator, the approximate asymptotic inverse operator is a better choice. Under the ideal assumptions of high-frequency limit and infinite aperture, the approximate asymptotic inverse operator can be regarded as the inverse of the modeling operator. Although these assumptions may not be fully met in actual situations, the approximate asymptotic inverse operator is closer to the true inverse operator than the adjoint operator. This advantage allows the inverse effect to be achieved in fewer iterations, providing a more computationally efficient solution. With this approach, faster and more accurate imaging results can be obtained in fields such as geological exploration and seismic data processing.

The least-squares reverse time migration method, system, terminal and storage medium in the embodiments of the present disclosure are described below with reference to the accompanying drawings. In view of the problem that the conventional least-squares migration technology adopted in the prior art requires a large iteration number for imaging, resulting in low imaging efficiency, the present disclosure provides a least-squares reverse time migration method, in which an approximate asymptotic inverse operator for the scattering potential is obtained based on the approximate asymptotic inverse operator for the reflectivity function and the relationship between the reflectivity function and the scattering potential, and imaging is performed with less iteration number through the approximate asymptotic inverse operator. In this process, the wavefield at the receiver positions is used as boundary conditions for the back-propagated receiver-side wavefield (amplitude preserved), which reduces the iteration number, improves the imaging efficiency, and ensures the accuracy of imaging. As a result, the technical problem that the conventional least-squares imaging technology used in the previous work requires a large iteration number for imaging, resulting in lower imaging efficiency, is solved.

The present disclosure can significantly improve the convergence speed and greatly reduce the amount of calculation. The desired imaging effect can be achieved with a relatively small iteration number, for example, 3 to 5 iterations. The improvement not only optimizes the imaging process, but also provides a more efficient and practical technical solution for fields such as geological exploration and resource detection.

The technical solution of the present disclosure is described in detail with embodiments below. The following embodiments can be combined with each other, and the same or similar concepts or processes may not be described in detail in some embodiments.

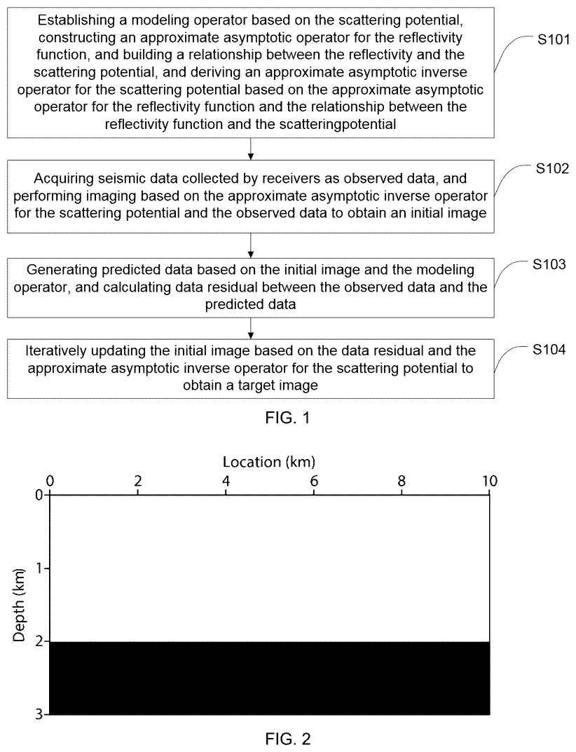

The least-squares reverse time migration method according to an embodiment of the present disclosure is shown in FIG. 1, and the least-squares reverse time migration method includes the following steps:

In step S101, establishing a modeling operator based on the scattering potential, constructing the approximate asymptotic operator for the reflectivity function, and building a relationship between the reflectivity and the scattering potential, and deriving an approximate asymptotic inverse operator for the scattering potential based on the approximate asymptotic operator for the reflectivity function and the relationship between the reflectivity function and the scattering potential.

In one implementation, the modeling operator based on the scattering potential and the approximate asymptotic inverse operator for the scattering potential adopted in the present embodiment of the present disclosure form a pair of operators to implement iterative inversion. The modeling operator and the approximate asymptotic inverse operator are described in detail as follows:

The modeling operator describes the process of seismic waves being excited by the source, propagating to the underground medium, interacting with the scattering potential of the medium, generating scattering or reflection, and then propagating upwards to be acquisition surface and then recorded by the receivers. The present process can be expressed by the formula (modeling operator) as follows:

$$δ p ( {x}_{r} , ω ; {x}_{s} ) = {\int }_{Ω} i ω 𝒞 ( y ) f ( ωG ( y , ω ; {x}_{s} ) {𝒱}_{PP} ( y , θ ) G ( {x}_{r} , ω ; y ) d Ω \qquad ( 1 )$$

Among them, δp is a reflected wavefield recorded by receivers, xᵣ is a coordinate of receiver, xₛ is a coordinate of a source point, y is a coordinate of a point in space, ω is an angular frequency, i is the imaginary unit, [symbol] is a coefficient related to an underground medium and an equation adopted, f is a source function, G is the Green's function, [symbol] is a real underground scattering potential, θ is a scattering angle, i.e. the angle between the incident direction and the reflected direction, and Ω is the integration domain.

The approximate asymptotic inverse operator back-propagates the recorded data on the acquisition surface back to the underground by adopting the amplitude-preserved back-propagation technology, and then extracts the useful information of the underground by adopting the amplitude-preserved imaging condition.

The amplitude-preserved back-propagation technology is obtained based on the second kind of the Rayleigh integral (applicable to acoustic isotropic and acoustic anisotropic cases):

$$δ p ( x , ω ; {x}_{s} ) = - {\int }_{{S}_{0}} 2 \frac{\partial {G}^{†} ( {x}_{r} , ω ; x )}{\partial {n}_{0}} δ p ( {x}_{r} , ω ; {x}_{s} ) {dx}_{r} \qquad ( 2 )$$

Among them, † represents the complex conjugate, S₀ is an acquisition surface, and n₀ is the normal direction of the acquisition surface.

It can be understood that δp(xᵣ, ω; xₛ) is the wavefield exited by the source xₛ, propagating downwards and then reflected back to the surface, and is recorded by the receiver at position xᵣ. Therefore, the wavefield contains information about the underground medium, such as the scattering potential. δp(x, ω; xₛ) is a wavefield obtained by the amplitude-preserved back-propagation, which adopts the second kind of the Rayleigh integral to propagate the seismic wavefield recorded on the acquisition surface back to a subsurface point x. In the present process, the complex conjugate derivative

$$\frac{\partial {G}^{†} ( {x}_{r} , ω ; x )}{\partial {n}_{0}}$$

of the Green's function G is adopted to back-propagate the wavefield, and then the true back-propagated receiver-side wavefield is obtained. The present process is usually adopted in the true imaging conditions to extract underground reflectivity information.

The true-amplitude imaging condition or the approximate asymptotic inverse operator for the reflectivity function can be expressed as:

$${ℛ}_{PP}^{est} ( x , γ ; {x}_{s} ) = {\vert Q ( x ; {x}_{s} ) \vert}^{- 1} {\int }_{ω} {[ f ( ω ) G ( x , ω ; {x}_{s} ) ]}^{†} δ p ( x , ω ; {x}_{s} ) d ω \qquad ( 3 )$$

Among them,

$${ℛ}_{PP}^{est}$$

is the inverted reflectivity image, γ is an incident angle, and Q is a source illumination compensation. It can be understood that, δp(xᵣ, ω; xₛ) represents the reflected wavefield recorded by the surface receiver, xᵣ is the coordinate of the receiver, xₛ is the coordinate of the source point, ω is the angular frequency. δp(x, ω; xₛ) represents the true back-propagated receiver-side wavefield at the position x, which is obtained by back-propagating the seismic record δp(xᵣ, ω; xₛ) on the surface to the underground position x.

Furthermore, the illumination compensation can be expressed as:

$$Q ( x ; {x}_{s} ) = {\int }_{ω} {\vert ( ω ) G ( x , ω ; {x}_{s} ) \vert}^{2} d ω \qquad ( 4 )$$

For a reflection surface, the incident angle γ at the reflection point is equal to a half of the scattering angle θ. Therefore, there is an intrinsic connection between the scattering potential and the reflectivity function:

$${𝒱}_{PP} ( y , θ ) = 2 {ℛ}_{PP} ( y , γ ) {cos}^{2} γ \qquad ( 5 )$$

Among them, [symbol] is a real reflectivity of the underground medium, and the incidence angle γ is equal to a half of the scattering angle θ. According to formula (3) and formula (5), the approximate asymptotic inverse operator for the scattering potential can be obtained as:

$${𝒱}_{PP}^{est} ( x , θ ; {x}_{s} ) = {\vert Q ( x ; {x}_{s} ) \vert}^{- 1} {\int }_{ω} {⌊ 2 f ( ω ) G ( w , ω ; {x}_{s} ) ⌋}^{†} {cos}^{2} γ δ p ( x , ω ; {x}_{s} ) d ω \qquad ( 6 )$$

Among them,

$${𝒱}_{PP}^{est}$$

is an extracted scattering potential image.

The embodiments of the present disclosure aim to improve the accuracy and efficiency of seismic data imaging through a series of refined calculation processes.

In step S102, acquiring seismic data recorded by receivers as observed data, and performing imaging based on the approximate asymptotic inverse operator for the scattering potential and the observed data to obtain an initial image.

It is worth noting that, if the model data is only a velocity model and assume the media is isotropic, the expression of the wavefield for back-propagation in the time domain is obtained in the prior art is:

$$\frac{1}{{v}_{0}^{2}} \frac{{\partial }^{2} P}{\partial {t}^{2}} - {∇}^{2} P = δ p ( {x}_{r} , t ; {x}_{s} )$$

Among them, v₀ represents the velocity; δp(xᵣ, t; xₛ) represents the wavefield in the time domain; and in the present embodiment of the present disclosure, if the model data is only a velocity model and assume the media is isotropic, the expression of the back-propagated wavefield is based on

$${\frac{1}{{v}_{0}^{2}} \frac{{\partial }^{2} PP}{\partial {t}^{2}} - {∇}^{2} PP = 0 and PP \vert}_{x = {x}_{r}} = δ p ( {x}_{r} , t ; {x}_{s} ) .$$

The initial image includes an initial scattering potential image and an initial reflectivity function image. The initial reflectivity function

$${ℛ}_{PP}^{est}$$

is obtained by applying the formula (3) to the observed data, and the initial scattering potential image

$${𝒱}_{P P}^{est}$$

is obtained by applying the formula (6).

In step S103, generating predicted data based on the initial image and the modeling operator, and calculating data residual between the observed data and the predicted data.

Based on the obtained initial scattering potential image

$${𝒱}_{P P}^{est} ,$$

the modeling operator (1) is adopted to generate predicted data, and the observed data is subtracted from the observed data to obtain the data residual.

In step S104, iteratively updating the initial image based on the data residual and the approximate asymptotic inverse operator for the scattering potential to obtain a target image.

In a possible implementation, the source-side wavefield and the receiver-side wavefield are obtained; the source-side wavefield and the receive-side wavefield are input into the approximate asymptotic inverse operator to obtain the update amount of the scattering potential image; based on the initial scattering potential image and the update amount, an updated scattering potential image is obtained; if the updated scattering potential image meets preset requirement, the updated scattering potential image is designated as the target image.

In the process of obtaining the source wavefield, the model data is first obtained, and the wave equation is solved according to model data. The boundary values of the source wavefield and the source wavefields at the last two time steps are recorded. The source wavefield is reversely reconstructed according to the recorded boundary values and the wavefields of the last two time steps. In the process of obtaining the receiver-side back-propagated wavefield, the observed data or the date residual is back-propagated to obtain the amplitude-preserved receiver-side wavefield.

In the present process, the amplitude-preserved receiver-side wavefield is obtained by injecting the data residual as boundary conditions to back-propagation. Different from the prior art that uses the data residual as sources to obtain the wavefield, the present disclosure reduces the iteration number and improves imaging efficiency.

In one possible implementation, the preset requirement is the convergence standard. During the process of determining whether the termination conditions are met, the modeling operator generates simulated update data based on the updated scattering potential image, and the data residual between the observed data and the predicted data are calculated. If the data residual is within the convergence standards, the updated scattering potential image is used as the target image.

In another implementation, the preset requirement is that the iteration number is met. During the process of determining whether the termination conditions are met, the current iteration number is obtained. If the current iteration number exceeds the specified number of iterations, the updated scattering potential image is used as the target image.

It is understandable that the preset termination condition (i.e., the preset requirement) can be the iteration number, such as 3, 4, or 5; or it can be a convergence criterion (i.e., the data residual is within a preset threshold). The updated scattering potential image after iterations that meets the condition is designated as the target image.

The embodiment of the present disclosure adopts the modeling operator for scattering potential, avoiding the difficulty of directly starting from the reflectivity function as the modeling operator. Through the binding of the reflectivity function and the scattering potential, the present disclosure can accurately invert for both the reflectivity function and the scattering potential at the same time.

It is worth noting that the traditional least-squares reverse time migration technology usually requires numerous iterations to achieve relatively ideal imaging results. However, using the method proposed in this invention, the number of iterations is significantly reduced, usually requiring only 3 to 5 iterations to achieve similar ideal imaging results. This significant improvement is due to the more efficient algorithm used in this invention, making the iterative process faster and more accurate. Since LSRTM requires iterative solutions and each iteration consumes substantial computational resources, this embodiment significantly reduces the computational burden by decreasing the required number of iterations, making the entire imaging process more efficient and resource-saving.

The least-squares reverse time migration method of the present disclosure is further described below through embodiments:

K10. Acquiring model data:

Relevant model data in the work area are collected, which include at least one of a velocity model and anisotropy parameters.

K20, Acquiring observed data:

Seismic reflection data in the work area are collected, usually in the form of common shot gathers.

K30. Performing, for each common shot gather, following steps combining with the model data in the work area:

K31. Extracting initial reflectivity function image and scattering potential image:

The initial reflectivity function image

$${ℛ}_{P P}^{est}$$

data using formula (3);

The initial scattering potential image

$${𝒱}_{P P}^{est}$$

is extracted using formula (6).

K32. Generating the predicted data:

The predicted seismic data is generated based on the extracted scattering potential image

$${𝒱}_{P P}^{est} ,$$

using the modeling operator (1).

K33. Calculating data residual:

The predicted data is subtracted from the observed data to obtain the data residual.

K34. Acquiring and reconstructing the source wavefield:

Combined with the model data, the wavefield at the source-side (Green's function) is obtained by solving the wave equation, and the boundary values of the source wavefield and the wavefields at the last two time steps are recorded;

The source wavefield is reversely reconstructed using the recorded boundary values and the wavefields at the last two time steps.

K35. Acquiring the receiver-side wavefield:

At the same time as step K36 is executed, the residual data is back-propagated through formula (2) to obtain the amplitude-preserved receiver-side wavefield.

K36. Updating the reflectivity function and the scattering potential images:

The update

$${Δℛ}_{P P}^{est}$$

of the reflectivity image is extracted using formula (3) to the data residual;

The update amount

$${Δ𝒱}_{P P}^{est}$$

of the scattering potential image is extracted by applying formula (6) to the data residual.

K37. Updating images:

An appropriate step size α is chosen to update the reflectivity function and the scattering potential images:

$${ℛ}_{P P}^{est} + {αΔℛ}_{P P}^{est} and {𝒱}_{P P}^{est} + {αΔ𝒱}_{P P}^{est} .$$

K38. Executing steps K34 to K37 in a loop until the preset maximum iteration number is reached.

K40. Superimposing, after the calculation of all shots is completed, the results are stacked to obtain the final reflectivity image and the final scattering potential image.

Through the above steps, the method based on the approximate asymptotic inverse operator can efficiently and accurately process seismic data and provide more accurate imaging results for geological exploration and resource exploration.

In order to verify the effectiveness of the efficient least-squares migration method based on the approximate asymptotic inverse operator of the present disclosure, a model including two horizontal layered structures is designed. As shown in FIG. 2, the velocity of the first layer of the model is 2450 m/s and the density is 1.9 g/cm³, the velocity of the second layer is 2550 m/s and the density is 2.0 g/cm³.

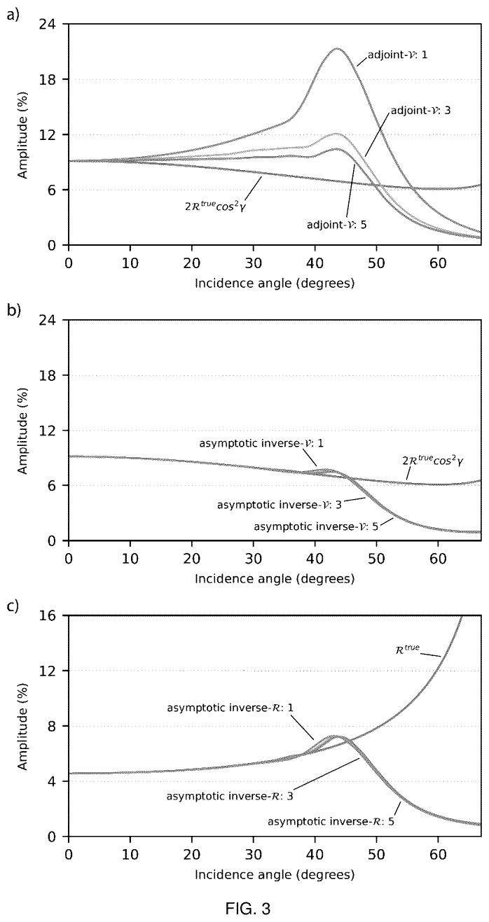

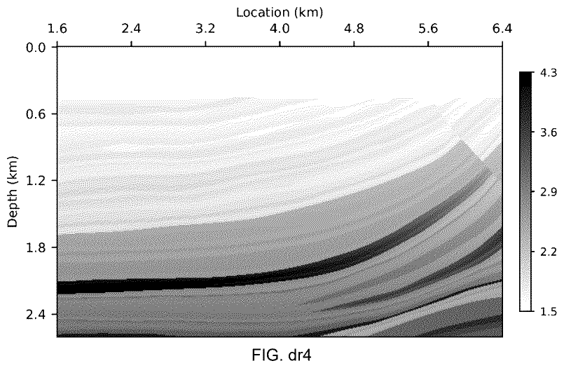

As shown in FIG. 3 is the comparison between the true values and the extracted peak amplitudes of the traditional method and the improved method.

FIG. 3 a) shows the extracted peak value of the scattering potential image obtained by the least-squares reverse time migration algorithm using traditional adjoint operator, which is compared with the theoretical value. After the first iteration, a deviation exists between the extracted peak value and the theoretical value, and the deviation still exists after 5 iterations.

FIG. 3 b) shows the comparison between the extracted peak value of the scattering potential image obtained by the least-squares reverse time migration algorithm using the approximate asymptotic inverse operator and the theoretical value. After the first iteration, within an effective incidence angle, the extracted peak amplitude value is consistent with the theoretical value, and the consistency remains good in subsequent iterations.

FIG. 3 c) shows the comparison between the extracted peak values of the reflectivity image obtained by the least-squares reverse time migration algorithm using the approximate asymptotic inverse operator and the theoretical value. The results show that after the first iteration, the results are already in consistent with the theoretical value, which proves that the approximate asymptotic inverse operator has a faster convergence speed.

In FIG. 3 a), b), and c), the ordinate represents the amplitude, and the abscissa represents the incidence angle.

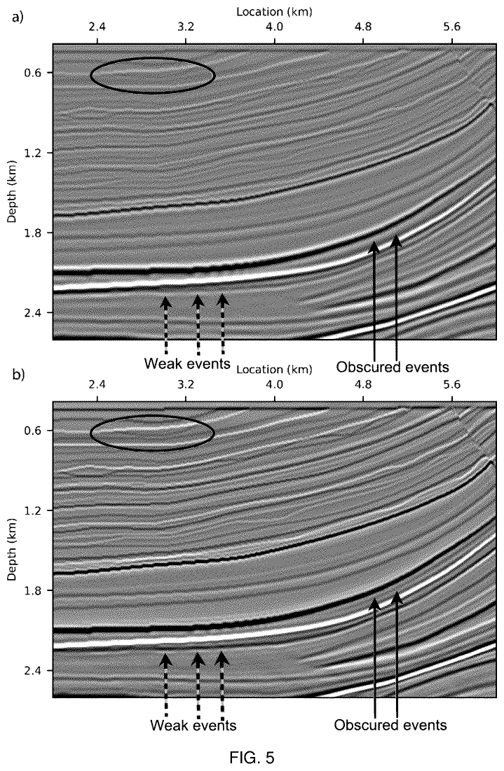

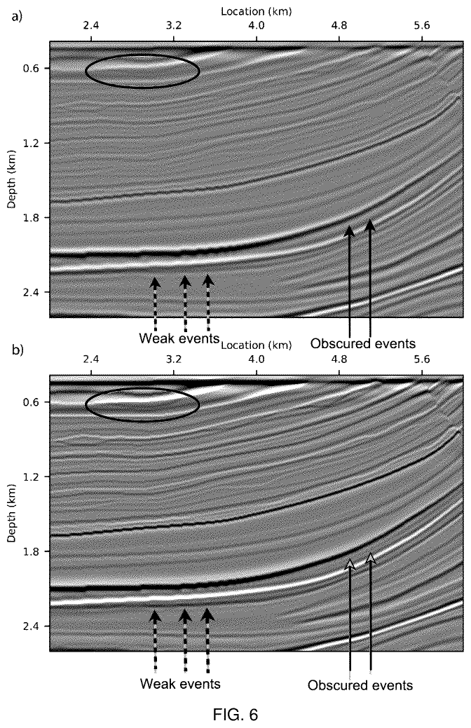

FIG. 4 shows a more complex model. FIG. 5 shows the scattering potential image obtained by using the least-squares reverse time migration with the approximate asymptotic inverse operator. FIG. 5 a) is the result of the first iteration, and FIG. 5 b) is the result of the fifth iteration. FIG. 6 shows the reflectivity image obtained by using the least-squares reverse time migration with the approximate asymptotic inverse operator, where FIG. 6 a) is the result of the first iteration, and FIG. 6 b) is the result of the fifth iteration. Even with a small iteration number (such as 5 iterations), significant improvements can be observed. For example, in the area indicated by the ellipse, the image becomes clearer after iteration; the weak events pointed by the dashed arrows becomes more obvious after five iterations and is separated from the strong event above. Additionally, the event indicated by the solid arrows which is initially obscured after the first iteration, is recovered after five iterations.

Next, a least-squares reverse time migration system provided according to an embodiment of the present disclosure is described with reference to the accompanying drawings.

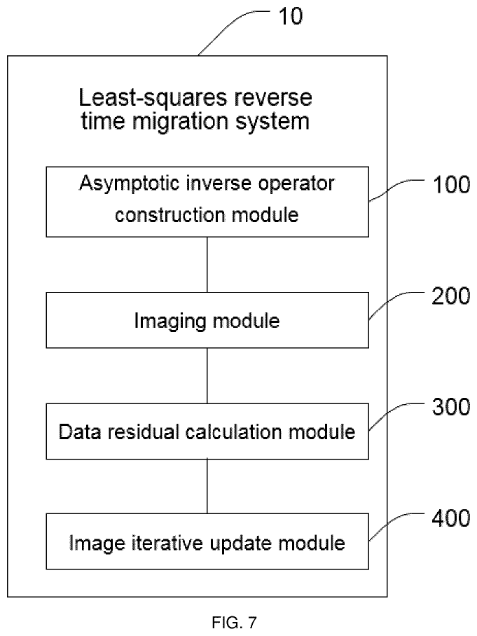

FIG. 7 is a block diagram of the least-squares reverse time migration system according to an embodiment of the present disclosure.

As shown in FIG. 7, the least-squares reverse time migration system 10 includes: an asymptotic inverse operator construction module 100, a data imaging module 200, a data residual calculation module 300 and an image iterative update module 400.

The asymptotic inverse operator construction module 100 is configured to establish a modeling operator based on scattering potential, establish an approximate asymptotic inverse operator for the reflectivity function, construct a relationship between the reflectivity function and the scattering potential, and obtain an approximate asymptotic inverse operator of the scattering potential based on the approximate asymptotic inversion operator for the reflectivity function and the relationship between the reflectivity function and the scattering potential.

The data imaging module 200 is configured to acquire seismic data collected by receivers as observed data, and perform imaging based on the approximate asymptotic inverse operator for the scattering potential and the observed data to obtain an initial image.

The data residual calculation module 300 is configured to generate predicted data based on the initial image and the modeling operator, and calculate the data residual between the observed data and the predicted data.

The image iterative updating module 400 is configured to iteratively update the initial image based on the data residual and the approximate asymptotic inverse operator for the scattering potential to obtain a target image.

It should be noted that the above explanation of embodiments of the least-squares reverse time migration method is also applicable to the least-squares reverse time migration system of the present embodiment, and will not be repeated here.

According to the least-squares reverse time migration system provided in the embodiment of the present disclosure, an approximate asymptotic inverse operator for the scattering potential is obtained by using the true-amplitude imaging condition for reflectivity function and the relationship between the reflectivity function and the scattering potential, and imaging is performed by the approximate asymptotic inverse operator with a smaller iteration number. In the present process, the receiver-side true-amplitude wavefield is obtained by injecting the recorded data or data residual as the boundary conditions at receiver positions rather than sources. The method greatly reduces the iteration number, improvs the imaging efficiency, and ensures the accuracy of imaging.

Therefore, the technical problem in the prior art that the traditional least-squares migration technology requires a large imaging iteration number, which results in lower imaging efficiency, is solved.

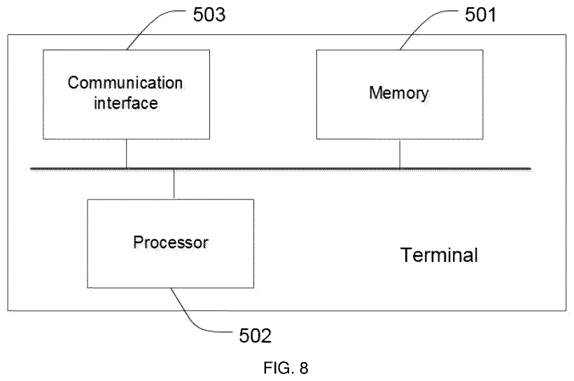

FIG. 8 is a schematic diagram of the structure of the terminal provided in an embodiment of the present disclosure. The terminal includes:

A memory 501, a processor 502, and a computer program stored in the memory 501 and executable on the processor 502.

When the processor 502 executes the program, the least-squares reverse time migration method provided in the above embodiments is implemented.

Furthermore, the terminal further includes:

A communication interface 503, configured for the communication between the memory 501 and the processor 502.

The memory 501 is used to store computer programs that can be executed on the processor 502.

The memory 501 may include a high-speed RAM memory, and may also include a non-transitory memory (non-volatile memory), such as at least one disk storage.

If the memory 501, the processor 502 and the communication interface 503 are implemented independently, the communication interface 503, the memory 501 and the processor 502 can be connected to each other through a bus to communicate with each other. The bus can be an Industry Standard Architecture (ISA) bus, a Peripheral Component (PCI) bus or an Extended Industry Standard Architecture (EIS) bus. The bus can be divided into an address bus, a data bus, a control bus, etc. For ease of representation, only one thick line is presented in FIG. 8, but it does not mean that there is only one bus or one type of bus.

Optionally, if the memory 501, the processor 502 and the communication interface 503 are integrated on a chip, the memory 501, the processor 502 and the communication interface 503 can communicate with each other through an internal interface.

The processor 502 may be a central processing unit (CPU), or an application specific integrated circuit (ASIC), or one or more integrated circuits configured to implement the embodiments of the present disclosure.

The present embodiment also provides a computer-readable storage medium on which a computer program is stored. When the program is executed by a processor, the least-squares reverse time migration method as described above is implemented.

An embodiment of the present disclosure provides a computer program product, including a computer program. When the computer program is executed by a processor, the least-squares reverse time migration method provided by any embodiment of the embodiment corresponding to FIG. 1 of the present disclosure is implemented.

In the description of this specification, the description with reference to the terms “one embodiment”, “some embodiments”, “example”, “specific example”, or “some examples”, etc. means that the specific features, structures, materials or characteristics described in conjunction with the embodiment or example are included in at least one embodiment or example of the present disclosure. In this specification, the schematic representations of the above terms do not necessarily refer to the same embodiment or example. Moreover, the specific features, structures, materials or characteristics described may be combined in any one or N embodiments or examples in a suitable manner. In addition, those skilled in the art may combine the different embodiments or examples and the features of the different embodiments or examples described in this specification, without contradiction.

In addition, the terms “first” and “second” are used for descriptive purposes only and should not be understood as indicating or implying relative importance or implicitly indicating the number of technical features indicated. Therefore, a feature defined as “first” or “second” may explicitly or implicitly include at least one of the features. In the description of this application, “N” means at least two, such as two, three, etc., unless otherwise clearly and specifically defined.

Any process or method descriptions in the flowchart or otherwise described herein should be understood to represent modules, segments, or portions of code, which include one or more (N) executable instructions for implementing specific logical functions or steps in the process. The scope of embodiments of the present application includes other implementations in which functions may be executed out of the order described or illustrated, including substantially concurrent or reverse order execution, depending on the functionality involved, as would be understood by those skilled in the art.

The logic and/or steps represented in the flowchart or otherwise described herein can be considered as a sequencing list of executable instructions for implementing logical functions and can be embodied in any computer-readable storage medium for use by or in connection with an instruction execution system, apparatus, or device, such as a computer-based system, processor-containing system, or other systems that can fetch instructions from the instruction execution system, apparatus, or device and execute those instructions. For purposes of this description, a “computer-readable storage medium” can be any medium that can contain, store, communicate, propagate, or transport the program for use by or in connection with the instruction execution system, apparatus, or device. More specific examples of the computer-readable storage medium (a non-exhaustive list) include the following: an electrical connection having one or more (N) wires (electronic device), a portable computer diskette (magnetic device), random access memory (RAM), read-only memory (ROM), erasable programmable read-only memory (EPROM or Flash memory), an optical fiber device, and a portable compact disc read-only memory (CDROM). Additionally, the computer-readable storage medium can even be paper or another suitable medium upon which the program is printed, as the program can be optically scanned from the paper or other medium into a computer memory using optical scanning and editing or other suitable processes to convert the program into electronic form for storage in a computer-readable storage medium.

It should be understood that various portions of the present application can be implemented in hardware, software, firmware, or combinations thereof. In the embodiments, the steps or methods may be implemented in software or firmware stored in a memory and executed by a suitable instruction execution system. For example, if implemented in hardware, they can be implemented using discrete logic circuits having logic gates for implementing various logic functions on data signals, application-specific integrated circuits (ASIC), programmable gate arrays (PGA), field-programmable gate arrays (FPGA), etc., or in any combination thereof known to those skilled in the art.

A person skilled in the art can understand that all or some of the steps carried by the methods of the various embodiments can be executed by a program instructing relevant hardware. The program can be stored on a computer-readable storage medium, and when executed, comprises one or more of the steps of the method embodiment.

Additionally, the functional units described in the various embodiments of the present application can be integrated into one processing module, can be physically separate units, or two or more units can be integrated into one module. The integrated module can be implemented in the form of hardware or as a software functional module. If the integrated module is implemented as a software functional module and sold or used as an independent product, it can also be stored in a computer-readable storage medium.

The storage medium mentioned above may be a read-only memory, a disk or an optical disk, etc. Although the embodiments of the present disclosure have been shown and described above, it can be understood that the above embodiments are exemplary and should not be understood as limiting the present disclosure. A person skilled in the art may make variations, modifications, replacements, and alterations of the above embodiments within the scope of the present disclosure.

It should be understood that the application of the present disclosure is not limited to the above embodiments. For those skilled in the art, improvements or modifications can be made based on the above description. All these improvements and modifications should fall within the scope of protection of the claims attached to this application.

Finally, it should be noted that the above embodiments are only used to illustrate the technical solution of the present disclosure, rather than to limit it. Although the present disclosure has been described in detail with reference to the embodiments, those skilled in the art should understand that they can still modify the technical solution described in the embodiments, or replace some or all of the technical features therein with equivalents. However, these modifications or replacements do not cause the essence of the corresponding technical solution to deviate from the scope of the technical solutions of the embodiments of the present disclosure.

What is claimed is:

1. A least-squares reverse time migration method, comprising:
establishing a modeling operator based on a scattering potential, constructing an approximate inverse operator for a reflectivity function, building a relationship between the reflectivity function and the scattering potential, and deriving an approximate asymptotic inverse operator for the scattering potential based on the approximate inverse operator for the reflectivity function and the relationship between the reflectivity function and the scattering potential;
acquiring seismic data collected by receivers as observed data, and performing imaging based on the approximate asymptotic inverse operator for the scattering potential and the observed data to obtain an initial image;
generating predicted data by using the modeling operator based on the initial image, and calculating data residual between the observed data and the predicted data; and
iteratively updating the initial image based on the data residual and the approximate asymptotic inverse operator for the scattering potential to obtain a target image.

2. The method according to claim 1, wherein the modeling operator based on a scattering potential is expressed as:
$$δ p ( {x}_{r} , ω ; {x}_{s} ) = {\int }_{Ω} i ω 𝒞 ( y ) f ( ω ) G ( y , ω ; {x}_{s} ) {𝒱}_{P P} ( y , θ ) G ( {x}_{r} , ω ; y ) d Ω ;$$
wherein δp is a reflected wavefield recorded by a receiver, xᵣ is a coordinate of the receiver, ω is an angular frequency, xₛ is a coordinate of a source point, i is imaginary unit, y is a coordinate of a point in space, [symbol] is a coefficient related to an underground medium and an equation adopted, f is a source function, G is a Green's function, [symbol] is a real underground scattering potential, θ is a scattering angle, and Ω is integration domain;
the approximate inverse operator for the reflectivity function is expressed as:
$${ℛ}_{P P}^{est} ( x , γ ; {x}_{s} ) = {\vert Q ( x ; {x}_{s} ) \vert}^{- 1} {\int }_{ω} {[ f ( ω ) G ( x , ω ; {x}_{s} ) ]}^{†} δ p ( x , ω ; {x}_{s} ) d ω ;$$
wherein
$${ℛ}_{P P}^{est}$$
is the inverted reflectivity image, γ is an incident angle, and Q is a source illumination compensation;
the relationship between the reflectivity function and the scattering potential is expressed as:
$${𝒱}_{P P} ( y , θ ) = 2 {ℛ}_{P P} ( y , γ ) {cos}^{2} γ ;$$
wherein [symbol] is a real reflectivity function of the underground medium, and incidence angle γ is equal to a half of scattering angle θ; and
the approximate asymptotic inverse operator for the scattering potential is expressed as:
$${𝒱}_{P P}^{est} ( x , θ ; {x}_{s} ) = {\vert Q ( x ; {x}_{s} ) \vert}^{- 1} {\int }_{ω} {⌊ 2 f ( ω ) G ( x , ω ; {x}_{s} ) ⌋}^{†} {cos}^{2} γ δ p ( x , ω ; {x}_{s} ) d ω ;$$
wherein
$${𝒱}_{P P}^{est}$$
is an inverted scattering potential image and † represents complex conjugate.

3. The method according to claim 2, wherein the back-propagated reflected wavefield in the approximate asymptotic operator for the scattering potential is expressed as:
$$δ p ( x , ω ; {x}_{s} ) = - {\int }_{{s}_{0}} 2 \frac{\partial {G}^{†} ( {x}_{r} , ω ; x )}{\partial {n}_{0}} δ p ( {x}_{r} , ω ; {x}_{s} ) d {x}_{r} ;$$
wherein S₀ is an acquisition surface, n₀ is a normal direction of the acquisition surface.

4. The method according to claim 3, wherein the initial image comprises an initial scattering potential image;
the iteratively updating the initial image based on the data residual and the approximate asymptotic inverse operator for the scattering potential to obtain a target image comprises:
simulating a source-side wavefield based on the source function and simulating a receiver-side wavefield based on the observed data or the data residual;
inputting the source-side wavefield and the receiver-side wavefield into the approximate asymptotic inverse operator for the scattering potential to obtain an update amount of the scattering potential image;
obtaining an updated scattering potential image based on the initial scattering potential image and the update amount; and
when the updated scattering potential image meets a preset requirement, designating the updated scattering potential image as the target image.

5. The method according to claim 4, wherein the receive-side wavefield is an amplitude-preserved receiver-side wavefield;
the acquiring a source-side wavefield and a amplitude-preserved receiver-side wavefield comprises:
acquiring model data, and solving the wave equation based on the model data to obtain the source-side wavefield; recording boundary values of the source-side wavefield and the wavefields of last two time steps;
reversely reconstructing the source-side wavefield based on the recorded boundary values and the wavefields of the last two time steps; and
back-propagating the observed data or the data residual to obtain the amplitude-preserved receiver-side wavefield.

6. The method according to claim 4, wherein the preset requirement is that a convergence criterion is met;
when the updated scattering potential image meets a preset requirement, designating the updated scattering potential image as the target image comprises:
generating the predicted data based on the modeling operator and the updated scattering potential image, and calculating an updated data residual between the observed data and the predicted data; and
when the updated data residual is within the convergence criterion, designating the updated scattering potential image as the target image.

7. The method according to claim 4, wherein the preset requirement is that an iteration number is met;
when the updated scattering potential image meets a preset requirement, designating the updated scattering potential image as the target image comprises:
obtaining a current iterative number; and
when the current iterative number is greater than a maximum iteration number, designating the updated scattering potential image as the target image.

8. A least-squares reverse time migration system, comprising:
an asymptotic inverse operator construction module, configured to establish a modeling operator based on scattering potential, construct an approximate asymptotic inverse operator for reflectivity function, build a relationship between the reflectivity function and the scattering potential, and derive an approximate asymptotic inverse operator for the scattering potential based on the approximate asymptotic inverse operator for the reflectivity function and the relationship between the reflectivity function and the scattering potential;
an imaging module, configured to acquire seismic data collected by receivers as observed data, and perform imaging by performing the approximate asymptotic inverse operator for the scattering potential on the observed data to obtain an initial image;
a data residual calculation module, configured to generate predicted data based on the initial image and the modeling operator, and calculate data residual between the observed data and the predicted data; and
an image iterative update module, configured to iteratively update the initial image by performing the approximate asymptotic inverse operator for the scattering potential on the data residual to obtain a target image.

9. A terminal, comprising a memory, a processor, and a least-squares reverse time migration imaging program stored in the memory and executable on the processor, the least-squares reverse time migration imaging program implements the steps of the least-squares reverse time migration method according to claim 1 when executed by the processor.
